(19) United States
(12) Patent Application Publication
(10) Pub. No.: US 2008/0139979 A1
(43) Pub. Date: Jun. 12, 2008

(54) VIBRATIONAL THERAPY ASSEMBLY ADAPTED FOR REMOVABLY MOUNTING TO A BED

(75) Inventors: Roger J. Talish, Hillsborough, NJ (US); Kenneth J. McLeod, Vestal, NY (US); Kenneth Urgovitch, Montague, NJ (US); Anthony Fresco, Melville, NY (US); Clinton T. Rubin, Port Jefferson, NY (US)

Correspondence Address: CARTER, DELUCA, FARRELL & SCHMIDT, LLP, 445 BROAD HOLLOW ROAD, SUITE 225, MELVILLE, NY, 11747, US

(73) Assignee: Juvent, Inc., Somerset, NJ (US)

(21) Appl. No.: 11/950,357

(22) Filed: Dec. 4, 2007

Related U.S. Application Data
(63) Continuation-in-part of application No. 11/488,227, filed on Jul. 18, 2006.
(60) Provisional application No. 60/700,092, filed on Jul. 18, 2005.

(51) Int. Cl. A61H 23/00; A61H 1/00

(52) U.S. Cl. 601/51; 601/61

(57) ABSTRACT

At least one apparatus capable of producing resonant vibrations, such as at least one vibrational therapy apparatus that includes at least one platform member having at least one vibrating plate assembly for providing vibrational energy is disclosed. The platform member is configured for mounting to a patient support structure such as a bed or a surface of a pallet. The vibrational therapy apparatus includes a mounting apparatus configured to receive the at least one vibrating plate assembly for securely positioning and removably mounting the at least one platform member to the patient support structure, such as with respect to a surface of the bed or of the pallet. A mounting apparatus is configured to support at least one apparatus capable of producing resonant vibrations, wherein the mounting apparatus is configured for and adapted for mounting the at least one apparatus capable of producing resonant vibrations to a patient support structure.

### PRIORITY

The present application is a Continuation-In-Part patent application of U.S. patent application Ser. No. 11/488,227 filed on Jul. 18, 2006 titled “Vibrational Therapy Assembly for Treating and Preventing the Onset of Deep Venous Thrombosis,” and which claims priority to a United States Provisional Application filed on Jul. 18, 2005 and assigned U.S. Provisional Application Ser. No. 60/700,092; the entire contents of both applications being incorporated herein by reference.

### BACKGROUND

1. Technical Field

The present disclosure relates generally to a non-invasive medical treatment apparatus. More particularly, the present disclosure relates to a dynamic motion therapy apparatus for performing vibrational therapy.

2. Description of the Prior Art

Vibrational treatment, produced from vibration and impact devices, is known to stimulate tissue growth in the human body. For example, U.S. Pat. No. 5,273,028 to McLeod et al. discloses an apparatus for stimulating bone growth in a living organism such as a human by transmitting vertical vibrations through a plate upon which the person stands. U.S. Pat. Nos. 5,103,806, 5,376,065, and 5,191,880, also to McLeod et al., claim methods for preventing osteopenia, and promoting growth, ingrowth, and healing of bone tissue, including bone fractures, through the step of subjecting bone to a mechanical load. U.S. Pat. No. 5,046,484 to Bassett et al. describes a method of providing passive exercise treatment to increase the size and strength of bone by transmitting vertical impact loads to the heel of a patient. U.S. Pat. No. 4,858,599 to Halpern claims a similar method for the prevention or alleviation of osteoporosis.

More recently, U.S. Pat. No. 6,620,117 to Johnson et al. discloses an apparatus utilizing horizontal vibration and the concept of independent control of vertical and horizontal motion. U.S. Pat. No. 6,607,497 to McLeod et al. discloses a method of using resonant vibrations for treating postural instability. U.S. patent application Ser. No. 11/207,335 to Talish, describes an apparatus and method for treatment of internal organs using resonant vibrations or vibrational stimulus.

Deep venous thrombosis (DVT) is the occlusion of a deep vein by a blood clot, i.e., thrombus. DVT generally affects the leg veins, such as, for example, the femoral vein or the popliteal vein, and occurs when the blood clot either partially blocks or completely blocks the flow of blood in the vein. A major risk associated with DVT is the development of pulmonary embolism, which occurs when a blood clot breaks loose from the walls of a vein and travels to the lungs, blocking the pulmonary artery or one of its branches.

Although there are several medical factors, such as injury, immobility and clotting disorders, which cause DVT other non-medical factors are also often culprits. For example, prolonged periods of sitting or lying, such as, for example, during an airline flight and a prolonged hospital stay which includes a prolonged period of immobility.

Various treatments have been developed to alleviate the effects of DVT. For example, intermittent pneumatic compression machines are used to improve blood circulation and prevent the formation of thrombi in the limbs of the patient. These devices typically include a pair of compression garments or sleeves which wrap around the patient's limbs, generally the legs. Each sleeve has a plurality of separate inflatable chambers which are connected via conduits to a source of compressed fluid, typically air. The chambers are sequentially inflated to provide a compressive pulse to the limb, thereby increasing blood circulation and minimizing the formation of thrombi. The compressive pulses begin around the portion of the limb farthest from the heart and progress sequentially towards the heart. For example, for a three-chambered leg sleeve, the ankle chamber is inflated first followed by the calf chamber, and then the thigh chamber. Typical compression devices are described in U.S. Pat. Nos. 4,013,069 and 6,610,021. Other methods of treatment for treating DVT include surgical procedures as well as medications, such as, anticoagulants.

However, because a patient may be susceptible to DVT and its effects with little or no warning, the best method against DVT and its effects is preventing the onset of DVT. For example, early and regular ambulation, i.e. walking, is a treatment that is recognized and recommended. Walking enhances blood flow by activating the body's muscle pumps, increasing venous velocity and preventing stasis. Nonetheless, walking is not a viable option for many people, such as elderly and/or infirm individuals. Moreover, walking is not always possible or safe, such as in an aircraft experiencing turbulence.

### SUMMARY

In one embodiment, the present disclosure relates to a vibrational therapy apparatus that includes at least one platform member including at least one vibrating plate assembly for providing vibrational energy. The at least one platform member is configured for mounting to a patient support structure. The vibrational therapy apparatus includes also a mounting apparatus configured to and adapted to support the at least one vibrating plate assembly for mounting the at least one platform member to the patient support structure. The mounting apparatus may be configured to and adapted to support the at least one vibrating plate assembly for removably mounting the at least one platform member to a patient support structure. The vibrational therapy apparatus may further include at least one positioner operatively associated with the at least one platform member for guiding patient tissue adjacent to the at least one vibrating plate assembly.

In one embodiment, the at least one vibrating plate assembly may provide vibrational energy in at least two configurations of the at least one positioner. In one embodiment, in one configuration of the at least two configurations, the at least one positioner may be substantially perpendicular to the at least one platform member. In yet another embodiment, in one configuration of the at least two configurations, the at least one positioner is in juxtaposed relation to the at least one platform member. The at least one positioner may be moveable between a first position and a second position.

In one embodiment, in a first configuration of the at least two configurations, the patient tissue contacts the at least one vibrating plate assembly, and, in a second configuration of the at least two configurations, the patient tissue does not contact the at least one vibrating plate assembly. The vibrational therapy apparatus may further include at least one locating member operatively associated with one of the at least one platform member and the at least one positioner.

The present disclosure relates also to a mounting apparatus configured to support at least one apparatus capable of producing resonant vibrations, wherein the mounting apparatus is configured for and adapted for mounting the at least one apparatus capable of producing resonant vibrations to a patient support structure. The mounting apparatus may be configured for and adapted for removably mounting the at least one apparatus capable of producing resonant vibrations to a patient support structure.

In one embodiment, the apparatus capable of producing resonant vibrations is a vibrational therapy apparatus that includes at least one platform member including at least one vibrating plate assembly for providing vibrational energy. The at least one platform member is configured for mounting to the patient support structure and the mounting apparatus is configured to and adapted to support said at least one vibrating plate assembly to mount said at least one platform member to the patient support structure.

The mounting apparatus may mount the at least one vibrating plate assembly substantially orthogonally with respect to the patient support structure. The mounting apparatus may include a support structure configured to and adapted to support the at least one apparatus capable of producing resonant vibrations to the patient support structure.

In one embodiment, the at least one apparatus capable of producing resonant vibrations is at least one of (a) a vibrational therapy assembly; (b) a vibrational therapy apparatus; (c) a vibrating plate assembly; and (d) an oscillating platform apparatus.

The present disclosure relates also to a vibrational therapy assembly that includes a first vibrational therapy apparatus. The first vibrational therapy apparatus has a first platform member including at least one vibrating plate assembly for providing vibrational energy. The first platform member is configured for and adapted for mounting to a patient support structure. The vibrational therapy assembly includes also a second vibrational therapy apparatus that has a second platform member including at least one vibrating plate assembly for providing vibrational energy. The second platform member is configured for and adapted for mounting to a patient support structure. The vibrational therapy assembly includes also connecting means for removably connecting the first and second vibrational therapy apparatus, and a mounting apparatus configured to and adapted to support the first vibrational therapy apparatus for mounting the first platform member to a patient support structure, and the mounting apparatus is further configured to and adapted to support the second vibrational therapy apparatus for mounting the second platform member to a patient support structure.

The vibrational therapy assembly may further include a first positioner operatively associated with the first platform member for guiding patient tissue adjacent the at least one vibrating plate assembly; and a second positioner operatively associated with the second platform member for guiding patient tissue adjacent the at least one vibrating plate assembly. In one embodiment, the at least one vibrating plate assembly of the first positioner provides vibrational energy in at least two configurations of the first positioner, and the at least one vibrating plate assembly of the second positioner provides vibrational energy in at least two configurations of the second positioner. In one embodiment, the means for removably connecting engages and disengages the first vibrational therapy apparatus from the second vibrational therapy apparatus. In one embodiment, the vibrational therapy assembly further includes a first locating member operatively associated with the first vibrational therapy apparatus; and a second locating member operatively associated with the second vibrational therapy apparatus.

In one embodiment, the first and second positioners are in juxtaposed relation to the first and second platform members, and the first vibrational therapy apparatus is in juxtaposed relation to the second vibrational therapy apparatus.

The present disclosure relates also to a vibrational therapy system that includes a patient support structure; a vibrational therapy apparatus that includes at least one platform member including at least one vibrating plate assembly for providing vibrational energy, wherein the at least one platform member is configured for mounting to the patient support structure; and a mounting apparatus configured to and adapted to mount the at least one platform member to the patient support structure.

In one embodiment, the patient support structure includes a receptacle member, and the mounting apparatus mounts the at least one platform member to the patient support structure via a restraining member configured with at least one engagement member fixedly secured to the receptacle member. In one embodiment, the restraining member may be a belt and the at least one engagement member may be a velcro pad at an end of the belt, and the receptacle member may be a velcro patch engaged by the pad.

In one embodiment, the mounting apparatus includes at least a first pair of joining members that are configured for interfacing therebetween and a second pair of joining members. At least one of the second pair is mounted to the patient support structure. The second pair of joining members are also configured for interfacing therebetween to mount the at least one platform member to the patient support structure.

The present disclosure relates also to a method for providing vibrational therapy. The method includes the steps of providing at least one apparatus capable of producing resonant vibrations; providing a patient support structure; mounting the at least one apparatus capable of producing resonant vibrations to the patient support structure; contacting patient tissue to the at least one apparatus capable of producing resonant vibrations; and actuating the at least one apparatus capable of producing resonant vibrations to produce resonant vibrations.

In one embodiment, the at least one apparatus capable of producing resonant vibrations is at least one vibrating plate assembly, and the method further includes the steps of: providing a platform member having the at least one vibrating plate assembly; providing a patient support structure; mounting the platform member to the patient support structure; guiding patient tissue over the at least one vibrating plate assembly using a positioner operatively associated with the platform member; and actuating the at least one vibrating plate assembly. The method may further include the step of adjusting the positioner relative to the platform member. The step of guiding patient tissue may include the step of having the patient stand on the positioner. The step of guiding patient tissue may include the step of placing at least a portion of a patient's leg onto the platform member.

### BRIEF DESCRIPTION OF THE DRAWINGS

The foregoing features of the present disclosure will become more readily apparent and will be better understood by referring to the following detailed description of preferred embodiments, which are described hereinbelow with reference to the drawings wherein:

FIG. 1 is a perspective view of a vibrational therapy assembly including two vibrational therapy apparatuses in a portable configuration in accordance with the present disclosure;

FIG. 1A is a perspective view of a vibrational therapy apparatus of FIG. 1 in an open configuration illustrating the internal components thereof in accordance with the present disclosure;

FIG. 2 is a perspective view of the two vibrational therapy apparatuses of FIG. 1, pivotally attached and in an open configuration, illustrating the internal components thereof in accordance with the present disclosure;

FIG. 3 is a schematic view of a vibrating plate incorporated in the apparatus in accordance with the present disclosure;

FIG. 4 is a perspective view of the vibrational therapy assembly of FIG. 1 illustrating a method for opening the assembly when in a portable configuration;

FIG. 5 is a perspective view illustrating a method for lifting the positioners of the vibrational therapy apparatus in accordance with the present disclosure;

FIG. 6 is a perspective view illustrating a method for disconnecting the two vibrational therapy apparatuses in accordance with the present disclosure;

FIG. 7 is a perspective view illustrating the separated vibrational therapy apparatuses of FIG. 6 provided on a bed for enabling vibrational treatment for enhancing blood flow in the legs to treat or prevent the onset of DVT in accordance with the present disclosure;

FIG. 8 is a perspective view illustrating two vibrational therapy apparatuses in a closed configuration, configured to deliver vibrational therapy to a patient standing on the apparatuses;

FIG. 9 is a perspective view illustrating the vibrational therapy apparatus of FIG. 8 providing vibrational energy to a patient;

FIG. 10 is a perspective view of one embodiment of a positioning mechanism positioning the vibrational therapy assembly of FIG. 5 with respect to a surface of a bed according to the present disclosure wherein the vibrational therapy assembly is positioned at an end of the bed;

FIG. 11 is an end view of the bed in FIG. 10 having a portion of the positioning mechanism;

FIG. 12 is a perspective view of one embodiment of a positioning mechanism positioning the vibrational therapy assembly of FIG. 5 with respect to a surface of a bed according to the present disclosure;

FIG. 13 is a top plan view of the positioning mechanism of FIG. 12 positioning the vibrational therapy assembly;

FIG. 14 is a side elevation view of the positioning mechanism of FIG. 10 positioning the vibrational therapy assembly of FIG. 5 with respect to the surface of a bed and illustrating a patient oriented vertically to actuate the vibrational therapy assembly;

FIG. 15 is a perspective view of an oscillating platform apparatus of a dynamic motion therapy system suitable for positioning with respect to a surface of a bed via a positioning mechanism according to the present disclosure;

FIG. 16 is a side elevation view of an exemplary patient table having a patient pallet suitable for receiving the positioning mechanism and the vibrational therapy assembly of the present disclosure, wherein the pallet is shown in the fully raised position;

FIG. 17 is an end elevation view of the patient table, wherein the pallet is shown in a fully raised position and wherein the pallet includes the vibrational therapy assembly of FIG. 5 at an end of the pallet and disposed with respect to a surface of the pallet;

FIG. 18 is an opposite side elevation view of the patient pallet, wherein one end of the pallet is shown in a fully raised position and an opposite end of the pallet is shown in a fully lowered position at a pitch angle and illustrating the vibrational therapy assembly of FIG. 5 at the lowered end of the pallet and disposed with respect to a surface of the pallet;

FIG. 19 is a perspective view of an exemplary engagement member and corresponding exemplary receptacle member for securely positioning the vibrational therapy assembly of FIG. 5 to the patient pallet;

FIG. 20 is a side elevation view of the exemplary patient table having a pallet and the vibrational therapy assembly of FIG. 3 or of FIG. 15 and another positioning mechanism and which are each positioned at an end of the pallet and wherein a patient is positioned on the pallet such that the feet of the patient are in contact with the vibrational therapy assembly;

FIG. 21 is a side elevation view of the exemplary patient table of FIG. 20 wherein one end of the pallet is shown in a fully raised position and an opposite end of the pallet is shown in a fully lowered position and illustrating the vibrational therapy assembly of FIG. 3 or of FIG. 15 and the positioning mechanism at the lowered end of the pallet and disposed with respect to a surface of the pallet;

FIG. 22 is a side view of a support structure of the present disclosure that may be used in conjunction with the positioning mechanisms of the present disclosure;

FIG. 23 is a perspective view of the support structure of FIG. 22;

FIG. 24 is a perspective view of another embodiment of a positioning mechanism positioning the vibrational therapy assembly of FIG. 3 or of FIG. 15 with respect to a surface of a bed according to the present disclosure;

FIG. 25 is a side elevation view of the positioning mechanism of FIG. 24 positioning the vibrational therapy assembly of FIG. 3 or of FIG. 15 with respect to the surface of a bed and illustrating a patient oriented vertically to actuate the vibrational therapy assembly;

FIG. 26 is a perspective view of one embodiment of a positioning mechanism positioning the vibrating plate assembly of FIG. 3 or of FIG. 15 on a side of the bed and with respect to a surface of a bed according to the present disclosure;

FIG. 27 is a side elevation view of the positioning mechanism positioning the vibrating plate assembly on a side of the patient table having a patient pallet and with respect to a surface of the patient pallet of FIG. 16, wherein the pallet is shown in the fully raised position;

FIG. 28 is an end elevation view of the patient table having the patient pallet of FIG. 16, wherein the pallet is shown in a fully raised position and wherein a patient is shown supported on a surface of the pallet and the positioning mechanism positions the vibrating plate assembly on the side of the patient pallet; and

FIG. 29 is an end view of a patient table having a patient pallet wherein the patient table further includes a pivot mechanism enabling the pallet and the patient to be rolled over to one side at a particular roll angle to interface with the vibrating plate assembly on the side of the patient pallet.

### DETAILED DESCRIPTION

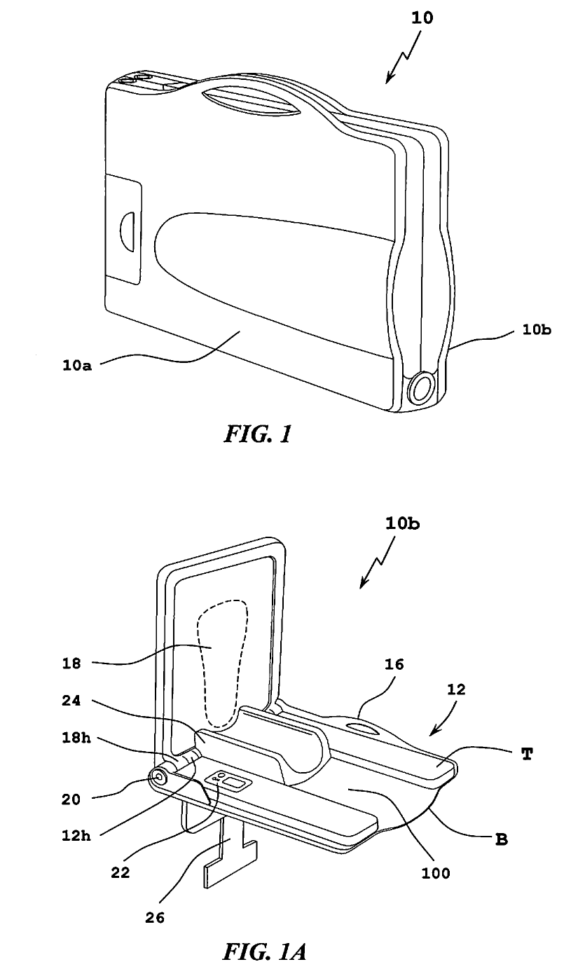

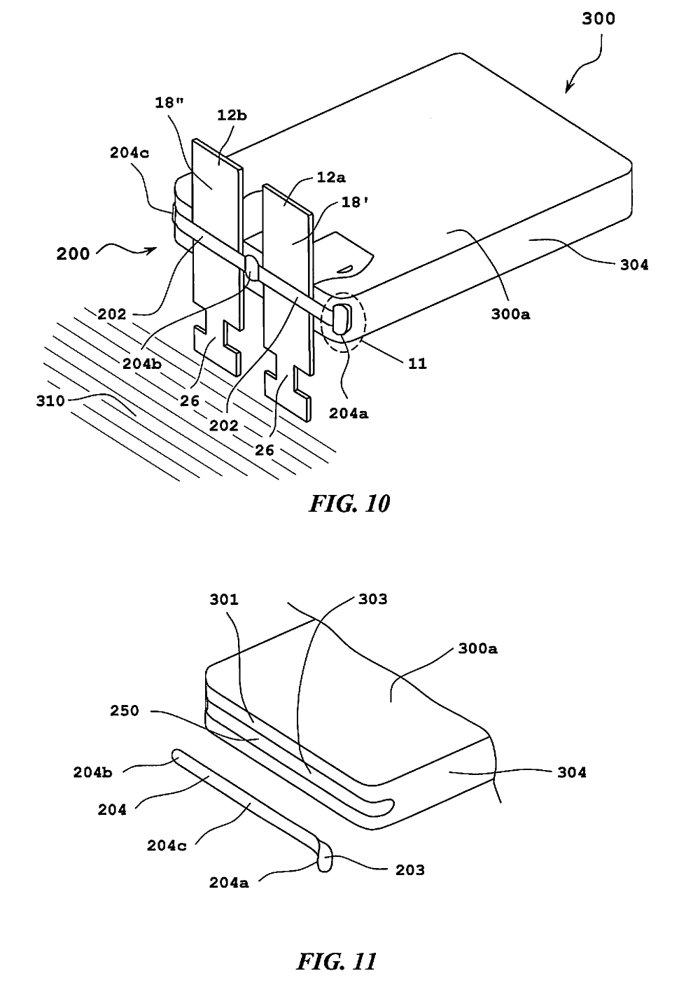

It is known to use vibrational treatment to treat conditions, such as postural instability, osteoporosis, etc., as described in U.S. Pat. Nos. 6,234,975; 6,561,991; and 6,607,497, the entire contents of which are incorporated herein by reference. The present disclosure provides for a dynamic motion therapy (DMT) vibrational therapy assembly for providing vibrational treatment for treating and preventing the onset of deep venous thrombosis (DVT), as described herein below with reference to FIGS. 1-9. The present disclosure also provides for a vibrational therapy assembly adapted for attachment to a pallet or bed as described hereinbelow with reference to FIGS. 10-29.

Exemplary embodiments of the presently disclosed vibrational therapy assembly and apparatus will now be described in detail with reference to the drawing figures in which like reference numerals identify identical or corresponding elements.

With initial reference to FIG. 1, a vibrational therapy assembly in accordance with the present disclosure is illustrated in a portable configuration, and is designated generally as vibrational therapy assembly 10. Vibrational therapy assembly 10 includes two vibrational therapy apparatuses 10a, 10b as described in the present disclosure. Vibrational therapy apparatuses 10a, 10b configured as a vibrational therapy assembly 10 is adapted to enhance blood flow and to treat and prevent the onset of DVT. However, one skilled in the art of vibrational treatment can envision conditions/ailments that can be treated or prevented using the assembly 10 and apparatus 10a, 10b.

FIG. 1A is a perspective view of vibrational therapy apparatus 10b, in an open configuration, illustrating the internal components thereof in accordance with the present disclosure. Apparatus 10b comprises platform member 12 and positioner 18. Platform member 12 includes a bottom portion B and top portion T. Platform member 12 includes at least one vibrating plate assembly 100, adapted to provide vibrational energy to patient tissue. The vibrational energy treats or prevents the onset of DVT.

Positioner 18 is operatively associated with platform member 12. In FIG. 1A, positioner 18 is hingedly attached to platform member 12. Pivot Pin 20 secures hinge portion 12h of platform member 12 to hinge portion 18h of positioner 18. Various other attachment means may be used such that positioner is pivotally attached to at least a portion of platform member 12 (e.g., a plurality of hinge sections, one or more living hinges, or more ball-joints, among others).

Positioner 18 may guide positioning of patient tissue adjacent to at least a portion of platform member 12, such as, for example, guiding or positioning of a patient tissue adjacent the vibrating plate assembly 100. Patient tissue, such as, for example, a leg and/or foot, is oriented such that vibrational energy generated by the vibrating plate assembly 100 is transferred to patient tissue. Patient tissue may receive vibration energy by direct contact with vibrating plate assembly 100. Patient tissue may also receive vibrational energy indirectly from vibration plate assembly 100, wherein vibrational energy is transferred through another portion of assembly 10b. For example, patient tissue may contact the positioner 18 or the pad 24 and vibrational energy is transferred from the vibrating plate assembly 100 through the positioner or the pad and to patient tissue.

Positioner 18 may lock in one or more angular positions relative to platform member 12. Hinge section may include a locking mechanism for locking positioner 18 into one or more of the angular positions relative to platform member 12.

The angular positions of the positioner 18 relative to the platform member 12 may be determined by the clinician, the type of medical therapy delivered to patient or the orientation of the patient receiving the vibrational therapy. Positioner 18, as shown in FIG. 1A, is positioned such that the angular relationship between the positioner 18 and the platform member 12 is substantially perpendicular and the platform member 12 is substantially horizontal.

In yet another embodiment of the present disclosure, pivoting mechanism may limit the angular movement of positioner 18, relative to the platform member 12, such that the angular condition of the positioner 18 in an open condition is optimal for a particular medical therapy. For example, for the treatment of DVT the pivoting mechanism may limit the angular movement of positioner 18, such that the maximum angular condition of the positioner 18 is substantially perpendicular to platform member 12.

Apparatus 10b may be repositioned or carried by grasping the handle 16 defined by the platform member 12.

Platform member 12 further includes at least one removable or fixed pad 24. Pad 24 supports the leg of a patient receiving vibrational treatment. The condition of pad 24 on platform member 12, relative to positioner 18, may be adjustable in order to provide proper support or positioning of the leg. Pad 24 may be placed against positioner 18 or spaced-apart from positioner 18.

Pad 24 may attach to platform member 12 to prevent movement during vibrational treatment. Various means of attachment may be used (i.e. velcro, snaps, buttons, clips, gel, adhesive or any combination thereof).

Apparatus 10b includes at least one locating member 26 for locating the apparatus 10b during use. Locating member 26 may locate or position apparatus 10b relative to a structure, such as, for example, a floor, a bed, examination couch, patient stretch, patient trolley, patient recovery trolley, patient pallet, a chair, a wheelchair, an airline seat, a car seat, a bus seat, a sofa, a recliner, a scooter, etc.

Apparatus 10b may be positioned at the foot of a bed, or similar structure, with locating member 26 extending downward along the mattress at the foot of a bed thus preventing the apparatus 10b from moving toward the head of the bed during use. Similarly, locating member 26 may be positioned between the mattress and a bed's footboard thus securing the apparatus 10b to the foot of a bed.

Locating member 26 may position or secure apparatus 10b to a location approximate to a seat, such as a wheelchair, an airline seat, car seat, bus seat, recliner or scooter. For example, locating member 26 may be adapted to interface with a wheelchair footrest such that a patient sitting in a wheelchair may receive vibrational therapy. Locating member may be adapted to locate apparatus 10b in close proximity to patient's seat, such as a seat in an airplane, car or bus such that patient may receive vibrational therapy while traveling. Locating member 26 may be adapted to locate or position apparatus 10b relative to a sofa or recliner by extending into or under the sofa or recliner such that patient may receive vibrational therapy in the comfort of their home.

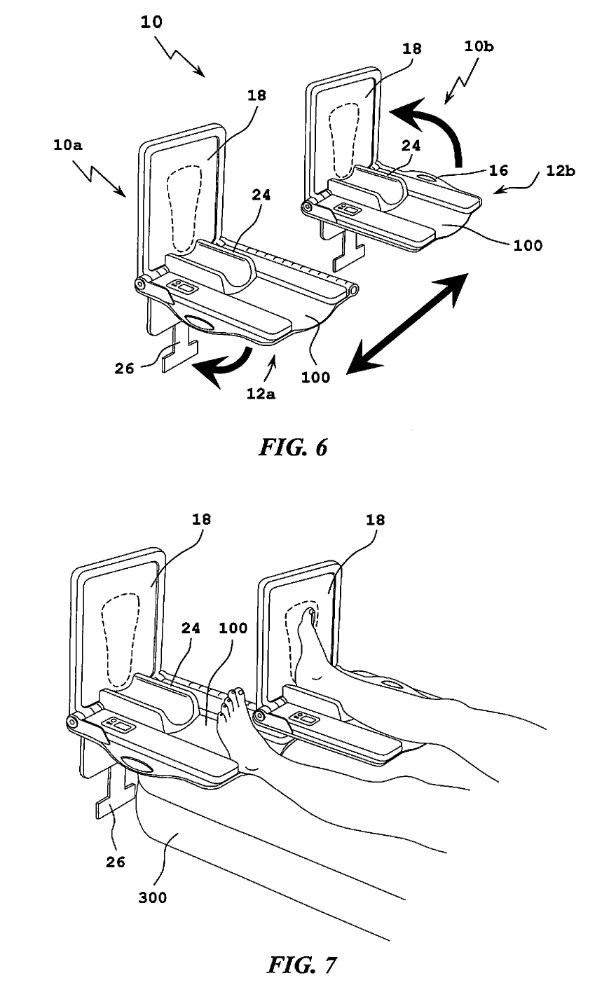

Locating member 26 may deploy from a first condition to a second condition. In the first condition, as illustrated in FIGS. 1 and 8, locating member 26 is substantially within or adjacent positioner 18 or platform member 12. In a second condition, as illustrated in FIGS. 1A and 6, at least a portion of locating member 26 is extended from positioner 18 or platform member 12. Locating member 26 may be pivotally attached to positioner 18 or platform member 12 wherein locating member 26 rotates about the pivot from the first condition to the second condition.

It is further envisioned to integrate the apparatus 10 with structure, such as to integrate the apparatus 10 with a bed, examination couch, patient stretch, patient trolley, patient recovery trolley, patient pallet, a chair, a wheelchair, an airline seat, a car seat, a bus seat, a sofa, a recliner, a scooter, etc.

Vibrational therapy apparatus 10b includes a low profile vibrating plate assembly 100 similar in structure and operation as the low profile vibrating plate system disclosed and described in U.S. Utility application Ser. No. 11/369,467 filed on Mar. 7, 2006 and in U.S. Provisional Application filed on Jul. 11, 2006.

Platform member 12 includes a low profile vibrating plate assembly 100 adapted for transmitting vibrational energy, as described in detail hereinbelow. Platform member 12 may further include a control panel 22 for controlling the operation of the vibrating plate assembly 100. Control panel 22 may include a user interface for programming the apparatus 10. Control panel 22 can be removed from platform member 12 and configured to operate as a remote control device in operative communication with vibrating plate assembly 100. Control panel 22, configured to operate as a remote control device, communicates via wired or wireless means with the apparatus 10b.

Apparatus 10b can also be provided with touch sensitive technology for sensing when the patient's foot is positioned to receive vibrational therapy. Vibrating plate assembly 100 may be configured to activate or actuate when it senses that the patient's foot is positioned to receive vibrational therapy, i.e. placed over the vibrating plate assembly 100 or in contact therewith or with pad 24.

Apparatus 10b may be powered by at least one battery for enabling the apparatus 10b to be mobile. Apparatus 10b may also include a power cord for plugging the apparatus 10b to an electrical outlet, when feasible, for charging or conserving battery power.

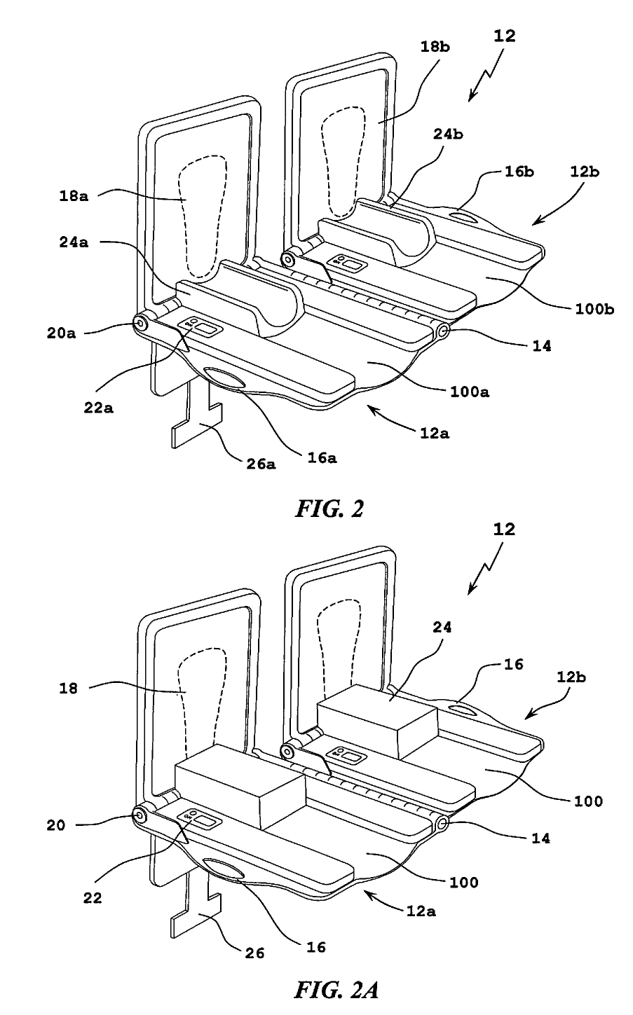

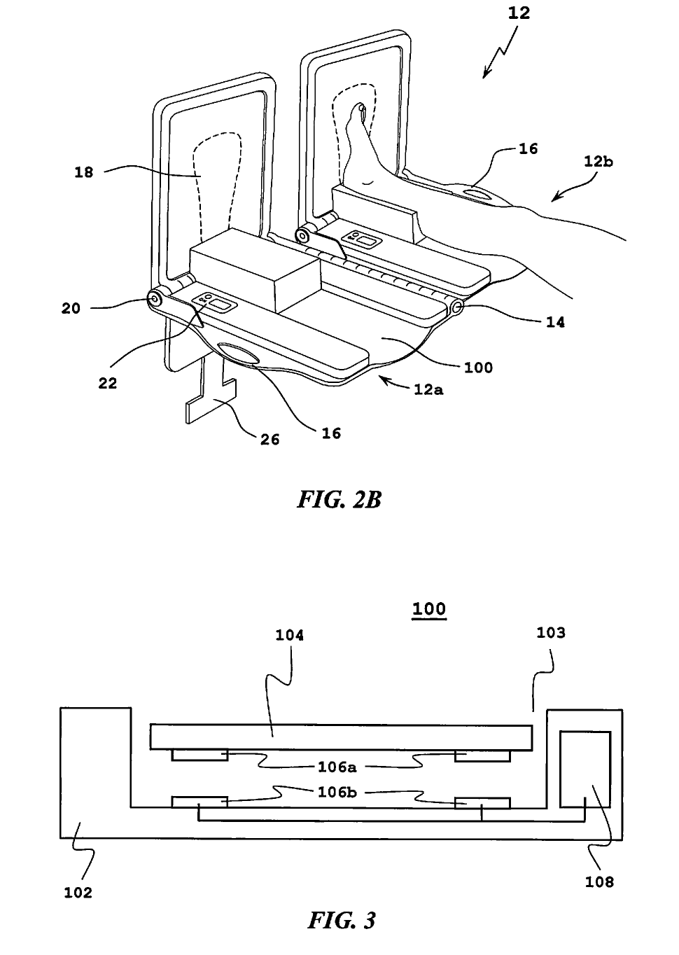

Referring now to FIG. 2, the vibrational therapy assembly 10 of FIG. 1 is illustrated with a first vibrational apparatus 10a and a second vibrational therapy apparatuses 10b. First vibrational apparatus 10a is operatively associated with second vibrational therapy apparatus 10b. Apparatuses 10a, 10b may be hingedly attached along one side with a connecting pin 14. First and second vibrational apparatuses 10a, 10b will disengage if connecting pin 14 is removed. Alternatively, the connecting means may include hinges, one or more ball and socket joints, one or more living hinges or other means of operatively associating two members suitable for the application.

Each vibrational apparatus 10a, 10b includes a platform member 12a, 12b and a positioner 18a, 18b operatively associated with each respective platform member 12a, 12b. Positioner 18a, 18b and the respective platform member 12a, 12b may be hingedly attached along one side with pivot pin 20a, 20b. Other means of forming a pivotal connection may be used, such as, for example, a plurality of hinges, one or more ball and socket joints, one or more living hinges or other means of operatively associating two members suitable for the application.

Platform members 12a, 12b may define handles 16a, 16b, and include control pads 22a, 22b and at least one vibrating plate assembly 100a, 100b. Handles 16a, 16b are disposed at respective sides of platform members 12a, 12b which are advantageously configured to enable one to grasp and transport the apparatus 10 when in the portable configuration as illustrated in FIG. 1.

Locating members 26a (26b not shown) may be used to locate or position assembly 10 relative to a structure. Other configurations for the locating member 26a other than the configuration shown by the figures are envisioned. It is further envisioned to integrate the assembly 10 with structure, such as to integrate the assembly 10 with wheelchair, a bed, a chair, a scooter, patient pallet, examination couch, patient stretch, patient trolley, patient recovery trolley, etc.

Referring again to FIG. 1A, in use, pad 24 supports or positions a patient's leg for receiving vibrational treatment. Vibrational energy from vibrating plate assembly 100 is transferred to the patient's leg directly or through pad 24. Pad 24 may be formed of one or more materials with at least one material adapted to transfers energy from the vibrating plate assembly 100 to the patient. Pad 24 may be formed from various materials, such as, for example, plastic, bean-like material, sand, foam, memory foam or any combination thereof. Pads 24 may be supplied in a variety of pre-formed shape or a configuration wherein clinician or patient selects a pad 24 that best fits and supports patient's leg.

Pad 24 may be reusable or may be used one or more times before being removable and disposed. Reusable pad may be used for several treatments prior to disposal or may be designed to be used for the life of the apparatus 10. Disposable pad may be used for a single treatment or may be used for two or more treatments before being discarded.

In yet another embodiment of the present disclosure, pad 24 may be formed of a moldable material such as foam, memory foam, clay, plaster, paste, gel, etc. In FIG. 2, pad 24a′ is a rectangular block in an unmolded or relaxed state. As further illustrated in FIG. 2, the material of pad 24a′ conforms to the patient's leg when the leg is applied as shown by pad 24b′. Pads 24a′, 24b′ may maintain the shape after the leg is removed or pads 24a′, 24b′ may return to the unmolded or relaxed state.

With reference to FIG. 3, low profile vibrating plate assembly 100 includes a low profile base 102 and a platform 104. Platform 104 rests within a cavity 103 formed on a top surface of base 102. A first set of magnets 106a is positioned on an underside portion of platform 104. Moreover, a second set of magnets 106b is positioned on a lower surface of cavity 103 of base 102. In a preferred embodiment, first set of magnets 106a is positioned in direct relation to second set of magnets, as illustrated in FIG. 3. In one embodiment, the paired magnets 106a and 106b each are set with equivalent polarities facing each other, thus providing a repellant force therebetween consequently causing platform 104 to levitate above base 102. Vibrating plate assembly 100 further includes a processor 108 in operable communication with the second set of magnets 106b. Preferably, the second set of magnets 106b includes adjustable magnetic properties (e.g., polarity, magnetic field intensity) controlled by a processor 108. First and second set of magnets 106a, 106b may include, for example, static magnetic field generating devices, such as, for example, permanent Ferro-magnets, electromagnets, and coils. Other dynamic magnetic field generating devices are also envisioned.

By varying the field intensity and/or alternating the polarity of the base magnets 106b a vertical vibration of platform 104 may be induced. The vibrational frequency is determined by the rate of change of the magnetic properties, while the amplitude of the vibration is determined by the magnetic field intensity. Additionally, the magnetic field intensity may be increased or decreased as needed, depending on a patient's weight, to properly condition and vibrate platform 104. In accordance with the present disclosure, a patient or user is permitted to stimulate and enhance blood flow in the limbs, in a manner described in detail hereinbelow.

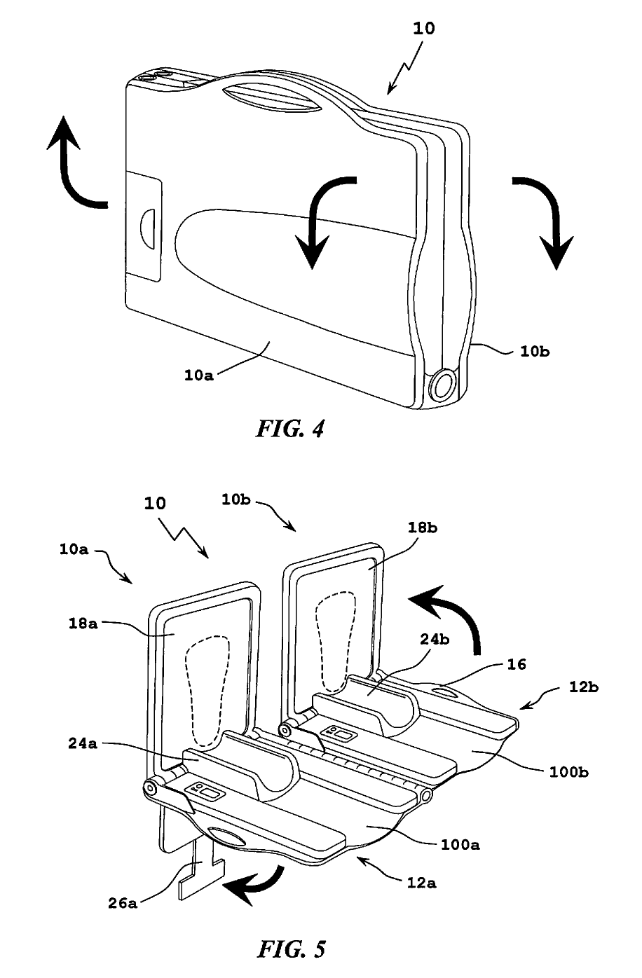

When used, assembly 10 is first switched from a portable configuration, as illustrated in FIGS. 1 and 4, to a configuration in which the two apparatuses 10a, 10b are in a closed configuration, as illustrated in FIG. 8. As discussed hereinbelow, assembly 10 may deliver vibrational therapy to a patient standing on apparatuses 10a, 10b in a closed configuration. Positioners 18a, 18b may be pivoted from a closed configuration to the open configuration, as illustrated in FIG. 5 by the large curved arrow, by pivoting each positioners 18a, 18b away from the respective platform member 12a, 12b. Locating member 26a (26b not shown) pivots from a first condition to a second position, as indicated by the small arrow.

As illustrated in FIG. 6, apparatuses 10a, 10b of assembly 10 may also be separated from each other, as indicated by the double arrow. Assembly 10 may be separated into two apparatuses 10a, 10b in either a closed configuration or an open configuration by removing the connecting pin (not shown). Apparatuses 10a, 10b while in a closed configuration may be used be used to deliver therapeutic vibrational energy in a closed configuration or positioners 18a, 18b may be lifted upward, as shown by the large arrow, to expose vibrating plate assembly 100a, 100b. Alternatively, positioners 18a, 18b may pivot to an open configuration, as indicated by the large arrow, prior to separating the apparatuses 10a, 10b, as indicated by the double arrow. Locating member 26a, 26b, for positioning apparatuses 10a, 10b on a structure, are deployable from a first condition to a second condition, as indicated by the small arrow.

As shown in FIG. 7, locating member 26a is used for positioning apparatus 10a, 10b on a structure, such as, for example, the edge of a mattress 300.

As illustrated in FIGS. 5-7, removable support pads 24a 24b are positioned on vibrating plate 100a, 100b prior to initiating vibrational treatment. It is envisioned that the assembly 10 may also be used without the support pads 24a, 24b.

As illustrated in FIGS. 6 and 7, apparatuses 10a, 10b may be detached, as shown by the double arrow in FIG. 6, for enabling treatment of one leg, if so desired, and for providing comfort to the patient. Each vibrating plate assembly 100a 100b has its own control panel 22a, 22b for enabling only one vibrating plate assembly 100a, 100b to be operated or actuated at a time, if so desired, for delivering vibrational energy.

FIG. 8 is a perspective view of the vibrational therapy assembly 10 including a first vibrational therapy apparatuses 10a and a second vibrational therapy apparatus 10b in a closed configuration. Positioners 18a, 18b are in juxtaposed relation to each respective platform member 12a, 12b. A human patient stands on assembly 12 with a foot positioned on each apparatus 10a, 10b. Proper foot placement may be indicated by a target, such as a footprint 19a, 19b or inset area (not shown) on positioner 18a, 18b. Pad 24a compresses due to the weight of the patient standing on positioner 18a, 18b, or pad 24a may be removed prior to positioning in a closed configuration. Positioners 18a, 18b contact at least a portion of platform members 12a, 12b, such that vibrational energy from vibrating plate assembly 100a, 100b is transferred to the respective positioner 18a, 18b. Handle 16b may be used to position or carry assembly 10.

In yet another embodiment of the present disclosure, positioner 18 includes at least one vibrational plate assembly, such as vibrating plate assembly 100, adapted to provide vibrational energy to patient tissue. In a closed configuration, vibrational plate assembly, of positioner, may deliver vibrational energy to patient tissue independent of the vibrational plate assembly 100 of platform member 12. For example, in the closed configuration, energy may be delivered from the vibrational plate assembly of positioner 18, and, in the open configuration, vibration energy may be delivered from the vibrational plate assembly 100 of platform member 12.

Alternatively, the first vibrational plate assembly 100 of platform member 12 and the vibrational plate assembly of positioner 18 may deliver vibrational energy simultaneously or may alternate delivery of vibrational energy.

The two or more vibrating plate assemblies may simultaneous deliver energy having the same frequency or may deliver vibrational energy having different frequencies.

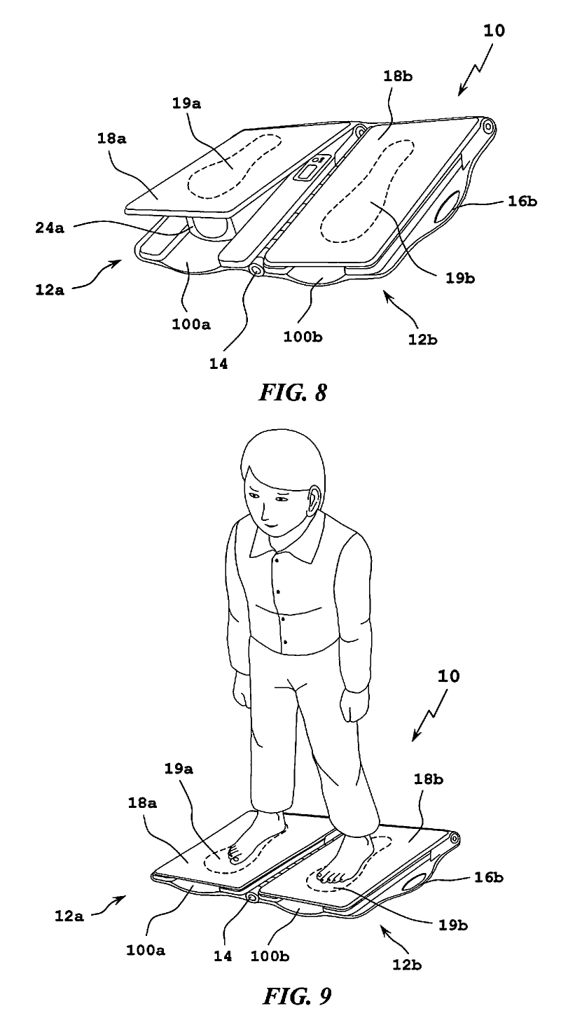

Use of vibrational therapy assembly 10 is illustrated in FIG. 9. Footprints 19a, 19b on positioners 18a, 18b guide positioning of patient tissue P adjacent to or over at least a portion of platform member 12a, 12b, such as, for example, the positioning of a patient's foot P adjacent the vibrating plate assembly 100a, 100b. Vibrational energy, generated by each vibrating plate assembly 100a, 100b, is transferred through the respective positioner 18a, 18b to patient tissue P.

With reference to FIGS. 2, 7 and 9, vibrational therapy apparatus 10a, 10b and assembly 10 provide vibrational energy to patient tissue P with positioners 18a, 18b in various configurations. In FIGS. 2 and 7, positioners 18a, 18b are substantially perpendicular to platform member 12a, 12b. In FIG. 9, positioners 18a, 18b are in a juxtaposed relation to the platform member 12a, 12b and the various portions of the platform member 12a, 12b, such as, for example, the vibrating plate assembly 100a, 100b.

With reference to FIGS. 1, 2 and 8, after use, apparatus 10a, 10b is switched from an open configuration, as shown in FIG. 2, to a closed configuration, as shown in FIG. 8, where each positioner 18a, 18b is in juxtaposed relation to the respective platform members 12a, 12b. For ease of storage and for transporting assembly 10, apparatuses 10a, 10b in a closed configuration, as shown in FIG. 2, are folded together such that apparatuses 10a, 10b are in juxtaposed relation to each other forming a portable configuration, as shown in FIGS. 1 and 4.

In yet another embodiment of the present disclosure, positioner can act as a platform or base for the apparatus for enabling the vibrating plates 100 to be positioned vertically with respect to the positioner. In this configuration, a user is able to rest his legs within the removable pads 24 while seated.

With reference to FIG. 7, vibrational therapy apparatus 10a, 10b of the present disclosure are used to enhance blood flow in order to treat and prevent the onset of DVT. The amount of treatment time and the number of treatment sessions per day depends on whether the patient is treating DVT or is preventing the onset of DVT, the age of the patient, whether the patient is infirm, the weight of the patient (the heavier the patient, the longer the treatment time), etc.

It is envisioned to provide a processor, with memory capable of executing a set of instruction stored in the processor's memory, for enabling the apparatus 10a, 10b to be programmable via either by the user through the user interface on the control pad 22a, 22b or by a remote connection via communications circuitry provided within the apparatus 10a, 10b and in operative communication with the processor as described in a U.S. patent application Ser. No. 11/487,677 filed on Jul. 17, 2006 titled “Dynamic Motion Therapy Apparatus Having a Treatment Feedback Indicator”, the entire contents of which are incorporated herein by reference. The processor can be programmed to sound an alarm when a treatment session should be started and to automatically shut-off the vibrating plate assembly 100a, 100b when the treatment time has lapsed. A memory within the processor can store patient treatment-related data and other information, such as name of patient, age, prescription medications being taken by patient, etc. The treatment related data can be transmitted to a remote monitoring station as described in the above-referenced U.S. patent application Ser. No. 11/487,677.

Referring to FIGS. 10-14, the present disclosure relates also to vibrational therapy assembly 10 wherein at least one platform member 12a, and as illustrated in FIGS. 10, 12 and 13 platform members 12a and 12b, is configured for mounting to a patient support structure, e.g., to a bed 300. As illustrated in FIG. 10, the platform members 12a and 12b are securely positioned with respect to a surface 300a of the bed 300 and also with respect to a floor 310 via the locating member 26. The patient support structure includes, but is not limited to, the bed 300, a patient pallet, a chair, seat or recliner, a gurney or other structure enabling a patient to lie thereon.

More particularly, the platform members 12a and 12b of the vibrational therapy assembly 10 of FIG. 5 each include the vibrating plate assembly 100 for providing vibrational energy and a mounting apparatus generally designated as 200. The platform members 12a and 12b are configured for mounting to the patient support structure, e.g., bed 300a, and particularly for securely positioning with respect to the upper surface 300a of the bed 300, and for being removably mounted therefrom. The mounting apparatus 200 is configured to and adapted to support the vibrating plate assembly 100 for securely positioning and mounting the platform member 12 to the patient support structure, e.g., with respect to the surface 300a of bed 300.

The bed 300 includes a receptacle member 250 disposed thereon and more particularly, the receptacle member 250 is disposed at an end 301 of the bed 300. The receptacle member 250 may be a velour-crochet, i.e., Velcro® (hereinafter referred to as “velcro”), strip disposed along the end 301 of the bed 300 (see FIG. 11).

The mounting apparatus 200 includes a restraining member 202 configured with at least one engagement member 204 that enables securely and reversibly fixing to the receptacle member 250 disposed on the end 301 of the bed 300. Alternatively, the receptacle member 250 may extend entirely around perimeter 304 of the bed 300.

The restraining member 202 may be a belt or strap having as the at least one engagement member 204, with at least first, second and third engagement member portions 204a, 204b and 204c, respectively, illustrated in FIG. 10 for example as velcro surfaces disposed at least at the ends 202a and 202b of the belt 202 and also in the center 202c. The velcro surfaces 203 of the first, second and third engagement member portions 204a, 204b and 204c are disposed to engage with the velcro surface 303 of the receptacle member 250. The restraining member 202 may be made from plastic, textile, metal or other suitable material.

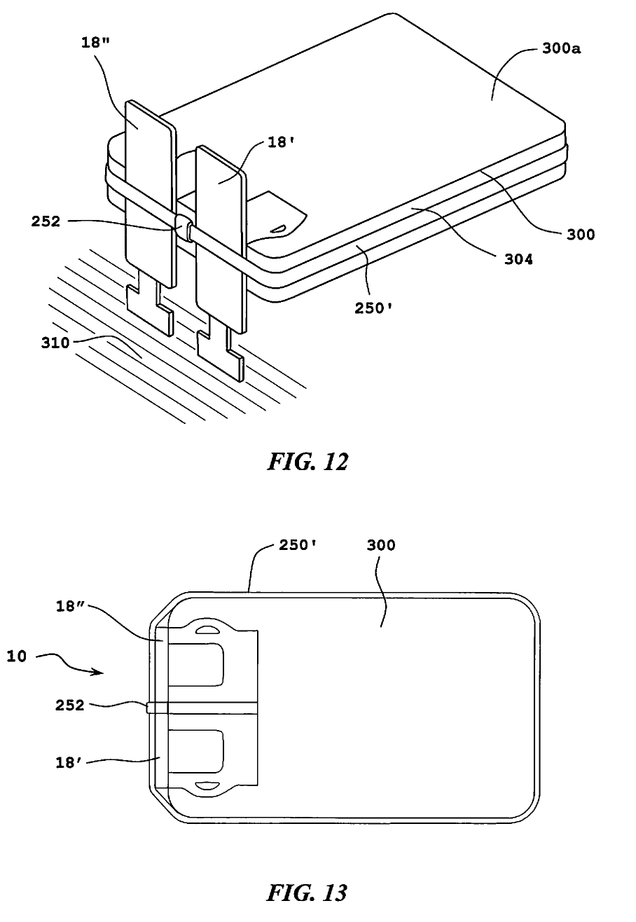

FIGS. 12 and 13 illustrate another embodiment of the mounting apparatus wherein mounting apparatus 250′ is a strap, belt or band that is of sufficient length to extend entirely around the perimeter 304 of the bed 300 and around rear surfaces 18′ and 18″ of the positioners 18a and 18b, respectively, and configured so as to position the platform members 12a and 12b with respect to the surface 300a of the bed 300, e.g., such that the platform members 12a and 12b are disposed on the surface 300a. In addition, the locating members 26 may be positioned to be in contact with the floor 310 to further securely position the platform members 12a and 12b with respect to the surface 300a of the bed 300. The mounting apparatus 250′ includes a joining member 252 such as a buckle engaging with an end of the mounting apparatus 250′, or a pair of interfacing velcro surfaces or other suitable means for joining.

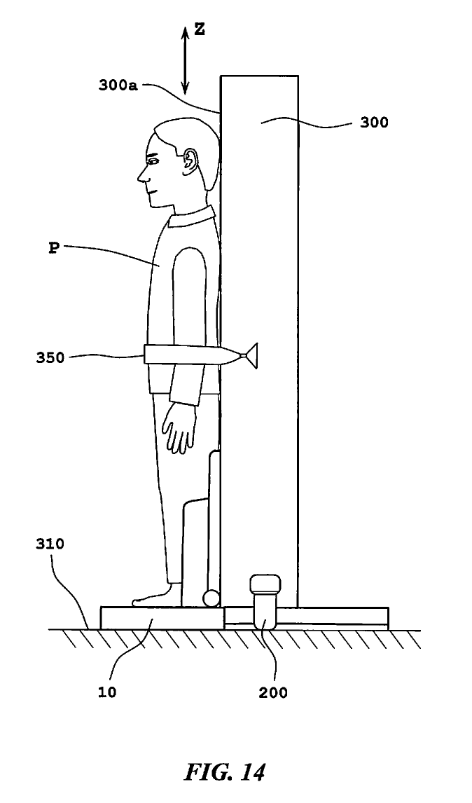

FIG. 14 illustrates the mounting apparatus 200 positioning the vibrational therapy assembly 10 with respect to the surface 300a of the bed 300 and illustrating a patient P oriented vertically with respect to the floor 310 to actuate the vibrational therapy assembly 10. Since the patient P may be ill or otherwise unable to stand upright, a patient restraint 350 may be attached to the bed 300 and extend across the body of the patient P to assist in holding the patient P in position. In the vertical position as shown, the weight of the patient P is sufficient to actuate the vibrational therapy assembly 10. In other positions, the vibrational therapy assembly 10 may be actuated manually and controlled manually by an operator, e.g., a doctor, a nurse, a medical technician or other trained personnel.

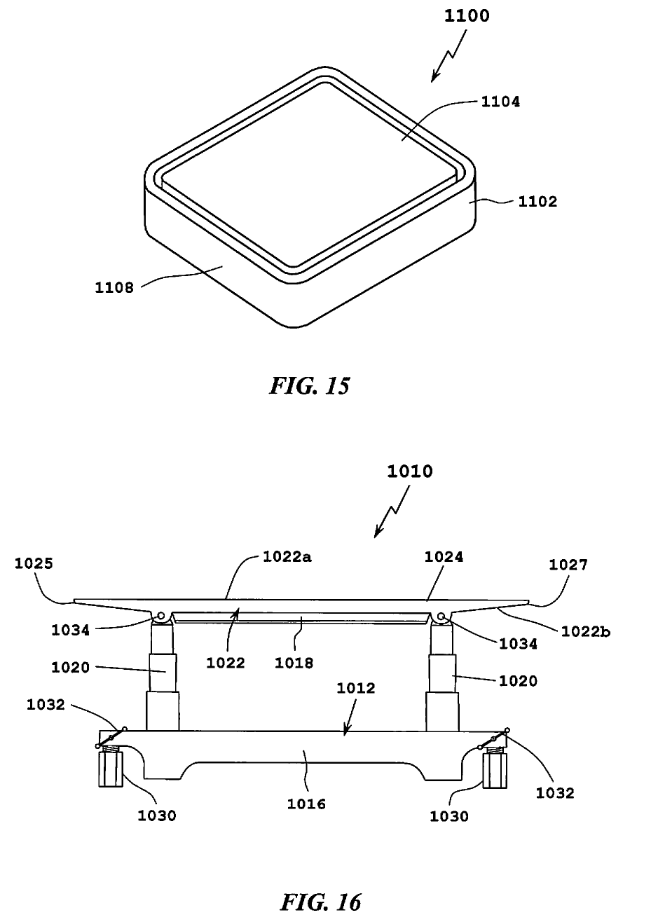

FIG. 15 illustrates an exemplary oscillating platform apparatus 1100 that may be used interchangeably with vibrating plate assembly 100. FIG. 15 shows a perspective view of the platform 1100, which is housed within a housing 1102. The oscillating platform apparatus 1100 is also referred to as a vibrational therapy apparatus, an oscillating platform, platform, vibration table or a mechanical stress platform. As defined herein, at least one apparatus capable of producing resonant vibrations includes at least one of the vibrational therapy assembly 10, the vibrational therapy apparatus 12a or 12b, the vibrating plate assembly 100 and the oscillating platform 1100, among others. Also, the frequencies of vibration imparted by the at least one apparatus capable of producing resonant vibrations are in the range between about 30 to about 90 cycles per second or Hertz (Hz), with a peak amplitude between about 0.04 g and about 0.4 g, where g is the acceleration of gravity (about 9.8 meters per second per second, i.e., m/s²). In one embodiment, the frequency of the at least one apparatus capable of producing resonant vibrations may be approximately 30 Hz and the peak amplitude may be about 0.3 g. The vibration waves may be sinusoidal but other waveforms are contemplated. In addition, as illustrated in FIG. 14, the energy propagated by the vibration waves is primarily directed along the Z-axis of the body of the patient P.

The housing 1102 includes an upper plate 1104, a lower plate (not shown), and side walls 1108. Note that the upper plate 1104 is generally rectangular or square-shaped, but can otherwise be geometrically configured for supporting a patient's body in an upright position on top of the upper plate 1104, or in a position otherwise relative to the platform 1100. Other configurations or structures can be also used to support a body in an upright position, above, or otherwise relative to, the platform 1100. The top plate 1104 is operated via an internal mechanism or oscillating mechanism (not shown). Such an exemplary oscillating platform is described in U.S. patent application Ser. No. 11/388,286 filed on Mar. 24, 2006 and Publication No. 2006/0217640 entitled “Apparatus and Method for Monitoring and Controlling the Transmissibility of Mechanical Vibration Energy During Dynamic Motion Therapy”.

In the vertical position as shown in FIG. 15, the weight of the patient P is sufficient to actuate the vibrational therapy assembly 1100. In other positions, the vibrational therapy assembly 1100 may be actuated manually and controlled manually by an operator, e.g., a doctor, a nurse, a medical technician or other trained personnel.

Thus, the mounting apparatus 200 and mounting apparatus 250′ are configured for and adapted for removably mounting the at least one apparatus capable of producing resonant vibrations, as defined above, to a patient support structure, as defined above, such as a bed 300.

Referring to FIGS. 16-18, 20-21, and 25-26, an exemplary embodiment of a patient table 1010 having a pallet 1022 that is suitable for interfacing with positioning mechanisms configured according to the present disclosure. U.S. Pat. No. 6,902,320 issued to McKenna describes such an exemplary patient pallet.

The patient table 1010 includes a generally C-shaped lower base 1012 having opposing laterally extending end portions 1014 connected by a longitudinally extending central portion 1016, and wherein the longitudinally extending portion is offset laterally from a longitudinally extending center line of the table. The table 1010 also includes an upper base 1018, front and rear lift arms 1020 extending upwardly from the central portion 1016 of the lower base 1012 and holding the upper base 1018 vertically above the lower base, and an elongated patient support pallet 1022 secured on one longitudinally extending side 1024 to the upper base 1018 and having an opposite longitudinally extending side 1026 substantially overhanging the laterally extending end portions 1014 of the lower base 1012. The patient support pallet 1022 also has opposing ends 1025, 1027 extending laterally between the sides 1024, 1026. The patient support pallet 1022 also includes an upper surface 1022a and a lower surface 1022b. The upper surface 1022a is generally planar so that the patient can be made to lie on the upper surface 1022a. The elongated pallet 1022 is shaped and sized for a patient to lie thereon, and, for the purposes of vibrational therapy, may be made from a material such as carbon fiber, plastic, steel or other suitable material.

As illustrated in FIGS. 16, 17, 18, 20, 21, 25 and 26, the lower base 1012 is supported by four tandem caster assemblies 1030 to allow the patient table 1010 to be rolled while supporting a patient (and also when not supporting a patient). Each caster assembly 1030 is also provided with a manually operated foot brake and steering lock 1032. The lower base 1012 is made from a strong and rigid material, such as steel.

The upper base 1018 is also made from a strong and rigid material, such as steel. In the exemplary pallet 1010 shown, the lift arms comprise telescoping hydraulic cylinders 1020. The hydraulic cylinders 1020 are spaced wide apart to provide room for maneuvering the C-Arm 1100. The hydraulic cylinders 1020 adjust the vertical position of the upper base 1018 between a fully lowered position to facilitate patient egress and ingress, and a fully raised position, as shown in FIG. 16, to provide a comfortable position for a person, such as a doctor or nurse, standing next to a patient supported on the pallet 1022. The hydraulic cylinders 1020 are especially useful in lowering the patient pallet 1022 to the level of a wheel chair, so that a person sitting in a wheel chair can simply drop an arm of the wheel chair and slide onto the patient pallet 1022 of the lowered table.

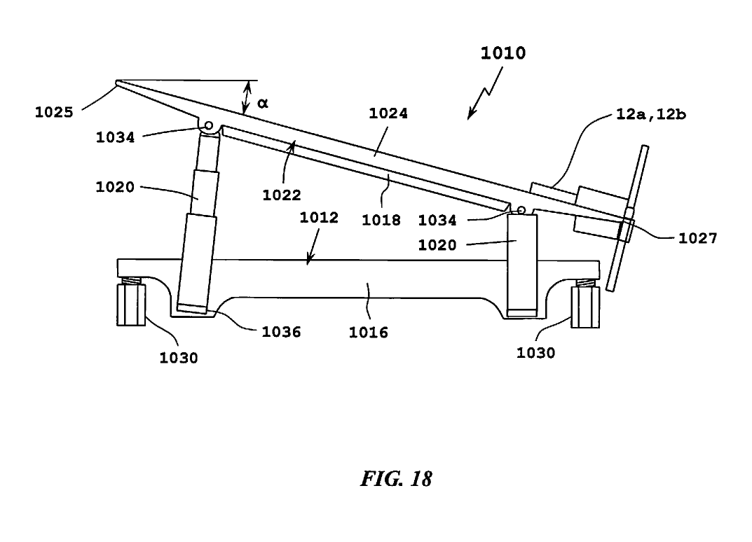

As shown in FIGS. 16-18, the hydraulic cylinders 1020 are pivotally connected at hinges 1034 to the upper base 1018, and, as shown in FIG. 18, at least one of the hydraulic cylinders 1020 is pivotally connected at a hinge 1036 to the lower base 1012. In this manner, the pallet 1022 can be moved or pitched at a pitch angle α to one of two orientations: a flat, horizontal position as shown in FIG. 16, and a Trendelenburg position shown in FIG. 18, where a patient's feet are raised above the patient's head, or the patient's head is raised above the patient's feet.

The overall height of the patient table 1010 in a fully lowered position may be selected to be about 50.4 centimeters (about 20 inches), for example, such that no footstool is required for a patient to get on or off the pallet of the patient table. The overall height of the patient table 1000 in a fully raised position may be selected to be about 81.3 centimeters (about 32 inches), for example. In the fully raised position, there is at least 50.4 centimeters (20 inches) of vertical clearance between the lower base 1012 and the pallet 1022. The pallet 1022 may be provided with a length of about 2.0 meters (about 80 inches), for example, and a width of about 66.8 to 81.3 centimeters (about 26 to 32 inches), for example. There may be provided a lateral clearance below the pallet 1022 of at least 50.4 centimeters (20 inches) between the side 1026 of the pallet and the lower base 1014.

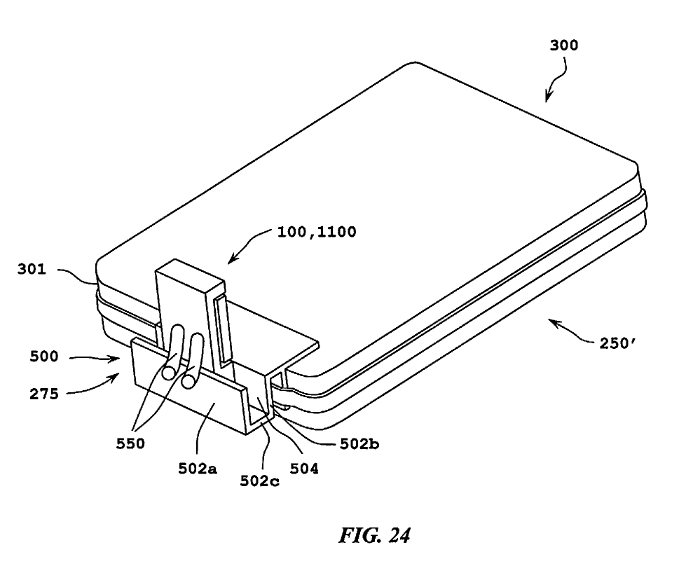

Referring to FIG. 24, those skilled in the art will recognize that, and understand how, the bed 300 may also be configured to pitch at a pitch angle such as pitch angle θ to interface with the vibrating plate assembly 100 or 1100 at the foot of the bed 300.

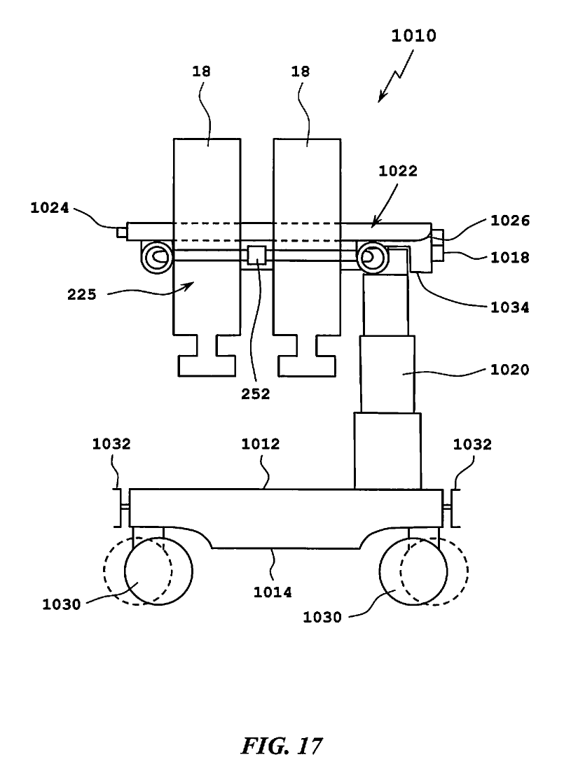

The pallet 1022 is configured to receive at least one apparatus capable of producing resonant vibrations, such as at least one vibrating plate assembly 100 for securely positioning the platform members 12a and/or 12b with respect to the surfaces 1022a and/or 1022b of the pallet 1022. More particularly, as illustrated in FIGS. 17 and 18, the platform members 12a and/or 12b are positioned to be disposed on the upper surface 1022a of the pallet 1022.

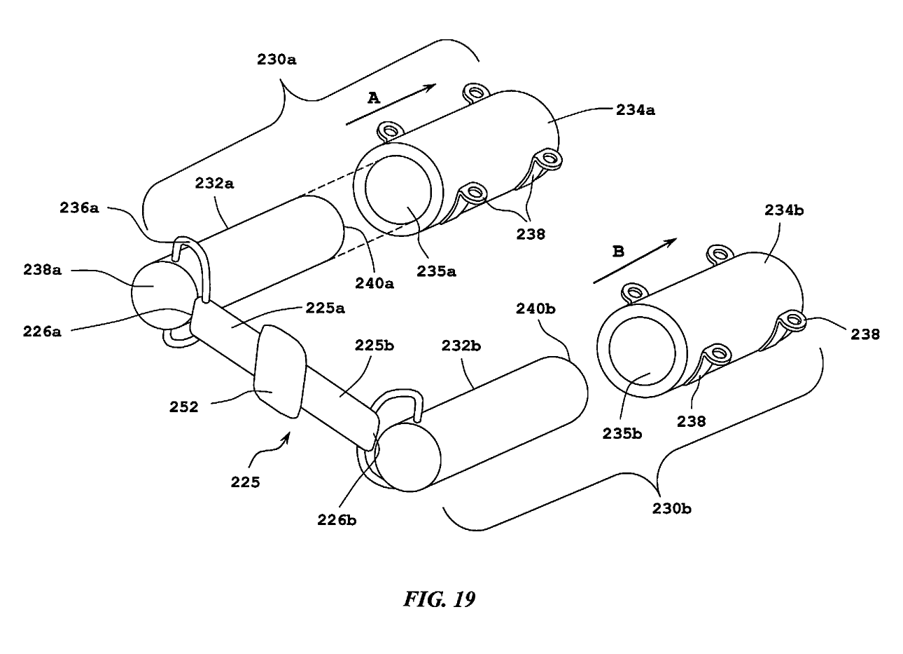

Referring to FIG. 19, an exemplary mounting apparatus 225 according to the present disclosure is illustrated which is configured to and adapted to support the platform members 12a and/or 12b of the vibrational therapy assembly 10. The mounting apparatus 225 includes at least a first pair of joining members configured for interfacing therebetween, e.g., a restraining member 262 configured as two portions 225a and 225b, respectively, of a belt or strap, that may be made from plastic, velcro, or other suitable material, and configured such that one end of one of the belt or strap portion 225a may be fastened with one end of the belt or strap portion 225b via the buckle 252. Alternatively, those skilled in the art will recognize that, and understand how, the buckle 252 may be substituted such that the ends of the belt or strap portion 225a and 225b may be formed of interfacing velcro surfaces which engage with one another. The buckle 252 may be made from metal, plastic, velcro or other suitable material.

The other end 226a of the belt or strap portion 225a may be fastened to at least a second pair of joining members, e.g, joining members 230a, the second pair of joining members being configured for interfacing therebetween, at least one of the second pair being mounted to the patient support structure, e.g., the patient pallet 1022. More particularly, the first pair of joining members 230a includes a male insertion member 232a and a female receptacle member 234a in interfacing relationship therewith. The female receptacle member 234a includes a hollow interior region 235a configured to receive the male insertion member 232a. Either the male member 232a or the female member 234a may include a semi-circular movable ring 236a circumferentially disposed to straddle the circumference of the particular member 232a or 234a, with the ring 236a being disposed in proximity to an end 238a of the male insertion member 232a as particularly illustrated in FIG. 19. The end 226a of the belt or strap portion 225a is fastened to the ring 236a. The other end 240a of the male insertion member 232a may be press-fit inserted into the hollow interior region 235a of the female receptacle member 234a, in the direction as illustrated by the arrow A to form a locking fit. Those skilled in the art will recognize that if necessary, and understand how, additional locking means may be employed to secure the male insertion member 232a to the female receptacle member 234a. In addition, the female member 234a may be securely attached to the lower surface 1022b of the patient pallet 1022 via U-bolts 238.

In a similar manner, the other end 226b of the belt or strap portion 225b may be fastened to a third pair of joining members, e.g., joining members 230b, the third pair of joining members being configured for interfacing therebetween, at least one of the third pair being mounted to the patient support structure, e.g., the patient pallet 1022. More particularly, the third pair of joining members 230b includes a male insertion member 232b and a female receptacle member 234b in interfacing relationship therewith. The female receptacle member 234b includes a hollow interior region 235b configured to receive the male insertion member 232b. Either the male member 232b or the female member 234b may include a semi-circular movable ring 236b circumferentially disposed to straddle the circumference of the particular member 232b or 234b, with the ring 236b being disposed in proximity to an end 238b of the male insertion member 232b as particularly illustrated in FIG. 19. The end 226b of the belt or strap portion 225b is fastened to the ring 236b. The other end 240b of the male insertion member 232b may be press-fit inserted into the hollow interior region 235b of the female receptacle member 234b, in the direction as illustrated by the arrow B to form a locking fit. Again, those skilled in the art will recognize that if necessary, and understand how, additional locking means may be employed to secure the male insertion member 232b to the female receptacle member 234b. In addition, the female member 234b may be securely attached to the lower surface 1022b of the patient pallet 1022 via U-bolts 238. The U-bolts may be made from plastic, aluminum, steel, or other suitable material. Similarly, the male and female members may be made from a material such as plastic, aluminum, steel or other suitable material. Those skilled in the art will recognize also, and understand how, the male and female receptacle members may be interchanged, e.g., such that the male members 232a and 232b are mounted to the lower surface 1022b of the patient pallet 1022.

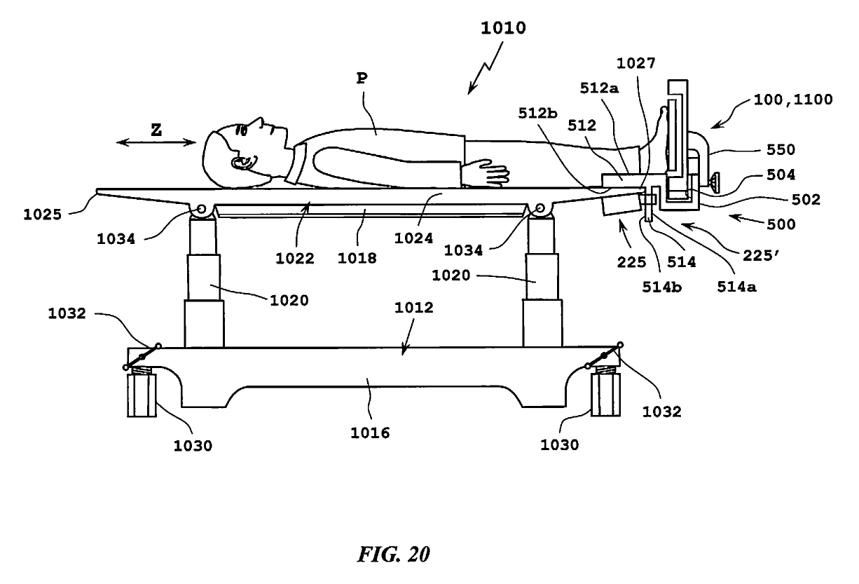

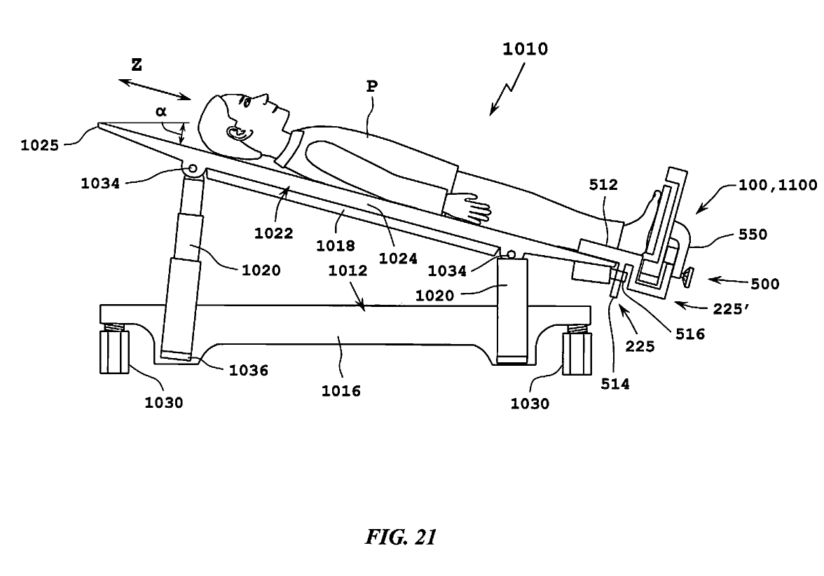

FIGS. 20-23 illustrate another embodiment of the present disclosure of a mounting apparatus 225′. In FIGS. 20-21, the mounting apparatus 225′ is configured to and adapted to removably support either the vibrational therapy assembly 100 or 1100 with respect to the surface 1022a of the pallet 1022 and the patient P is first in a horizontal position (see FIG. 20) and then in a reclining position (see FIG. 21). The mounting apparatus 225′ includes the mounting apparatus 225 that is securely attached to and mounted to the lower surface 1022b of the patient pallet 1022 and further includes a supporting structure 500 that in one embodiment may be configured as a rail for movably supporting and substantially orthogonally positioning the platform 104 of the vibrational therapy assembly 100 or the upper plate 1104 of the vibrational therapy assembly 1100 with respect to the upper surface 1022a of the patient pallet 1022.

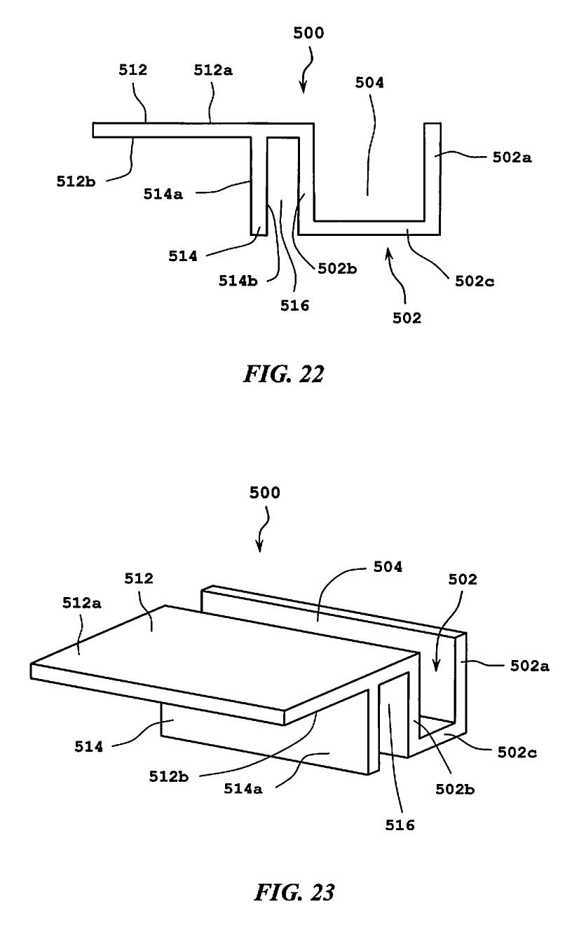

As also illustrated in FIGS. 22-23, the supporting structure 500 includes a channel member 502 that may be configured in a generally U-shaped configuration having a first wall 502a and a second wall 502 that may be unitarily joined via a base member 502c. The first wall 502a, the base member 502c and the second wall 502b form a first channel or open region 504 therebetween. The supporting structure 500 further includes a first projection 512 that may project substantially laterally from the second wall 502b to form an upper surface 512a and a lower surface 512b. The first projection 512 is configured with respect to the second wall 502b such that the lower surface 512b may be disposed on the upper surface 1022a of the patient pallet 1022. The supporting structure 500 may also include a second projection 514 that may project substantially orthogonally from the lower surface 512b of the first projection 512 to form a second channel or open region 516 between the second projection 514, the lower surface 512b of the first projection 512, and an outer surface 502b′ of the second wall 502b. In one embodiment, the support structure 500 may be fabricated from a lightweight material such as aluminum or plastic to reduce the total weight that the positioning mechanism 225 must support.

Referring again to FIGS. 20-21, the mounting apparatus 225 is attached to the lower surface 1022b of the patient pallet 1022 in proximity to the end 1027. As described above, the belt or strap portion 225a may be fastened to the belt or strap portion 225b via the buckle 252. In conjunction with the lower surface 512b being disposed on the upper surface 1022a of the pallet 1022, the support structure 500 is also disposed with respect to the patient pallet 1022 such that the second channel 516 can receive the belt or strap portions 225a and 225b. That is, the belt or strap portions 225a and 225b may serve to suspend the support structure.

In view of the foregoing, and as discussed above, the mounting apparatus 225 now is securely attached to the lower surface 1022b of the patient pallet 1022 and the vibrational therapy assembly 100 or 400 may be movably positioned in the first channel 504, that may be configured as a rail, for movably supporting and substantially orthogonally positioning the platform 104 of the vibrational therapy assembly 100 or the upper plate 1104 of the vibrational therapy assembly 1100 with respect to the upper surface 1022a of the patient pallet 1022. The base 102 of the vibrational therapy assembly 100 or the lower plate or base 1106 of the vibrational therapy assembly 1100 may further include one or more locking devices 550 that are disposed thereupon to enable locking the position of the vibrational therapy assembly 100 or 1100 with the first wall. In addition, as discussed above with respect to FIG. 14, the energy propagated by the vibration waves is primarily directed along the Z-axis of the body of the patient P.

FIGS. 24-26 illustrate one embodiment of the present disclosure wherein a mounting apparatus 275 includes the supporting structure 500 with the mounting apparatus 250′ (see FIG. 12) now engaged around the perimeter 304. The mounting apparatus 275 is positioned at the end 301 of the bed 300 and is configured to substantially orthogonally position the platform 104 of the vibrational therapy assembly 100 or the upper plate 1104 of the vibrational therapy assembly 1100 with respect to the surface 300a of the bed 300.

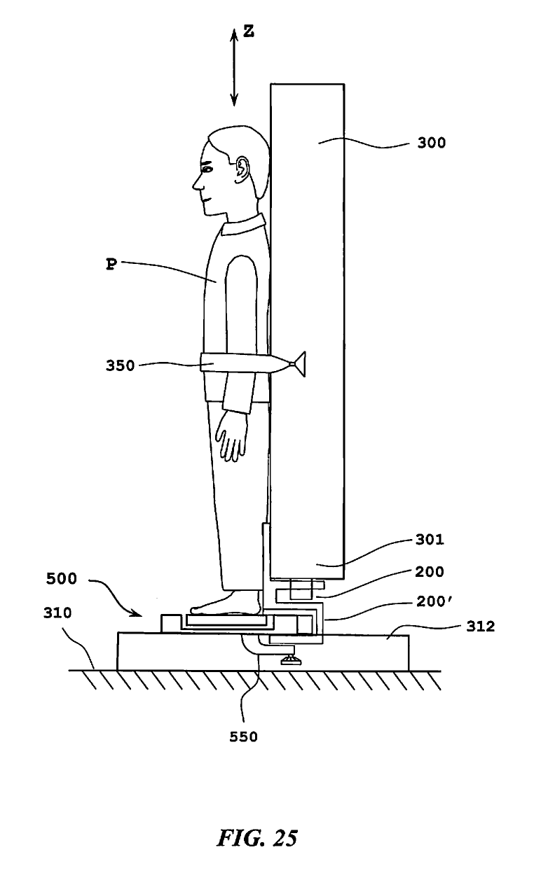

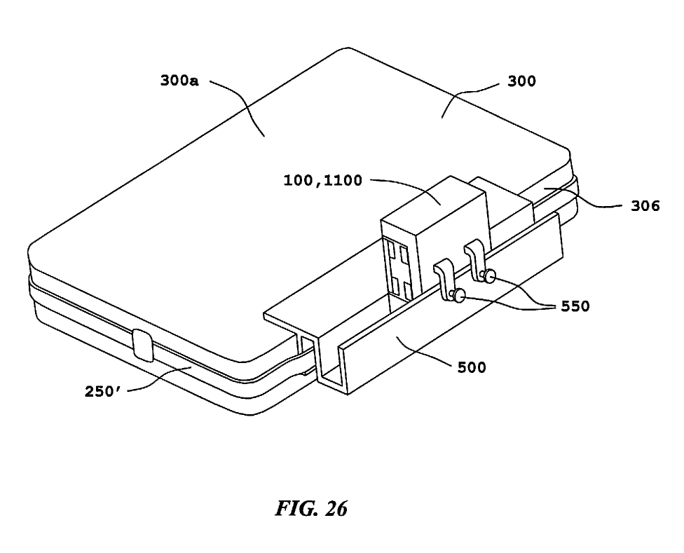

FIG. 25 illustrates a mounting apparatus 200′ which includes the mounting apparatus 200 (see FIG. 10) suspending the support structure 500 to position the vibrational therapy assembly 100 or 1100 at the end 301 of the bed 300 and with respect to the surface 300a of the bed 300 and illustrating the patient P oriented vertically with respect to the floor 310 to actuate the vibrational therapy assembly 10, with a flexible mat 312 between the end 301 of the bed 300 and the floor 310. As before, since the patient P may be ill or otherwise unable to stand upright, a patient restraint 350 may be attached to the bed 300 and extend across the body of the patient P to assist in holding the patient P in position. In the vertical position as shown, the weight of the patient P is sufficient to actuate the vibrational therapy assembly 100 or 1100. Again, as described above with respect to FIGS. 14 and 20, the energy propagated by the vibration waves is primarily directed along the Z-axis of the body of the patient P.

In other positions, such as illustrated in FIG. 26, wherein the mounting apparatus 250′, which includes the mounting apparatus 200 (see FIG. 10) suspending the support structure 500 to position the vibrational therapy assembly 100 or 1100 at a side 306 of the bed 300 and with respect to the surface 300a of the bed 300, the vibrational therapy assembly 100 or 1100 again may be actuated manually and controlled manually by an operator, e.g., a doctor, a nurse, a medical technician or other trained personnel.

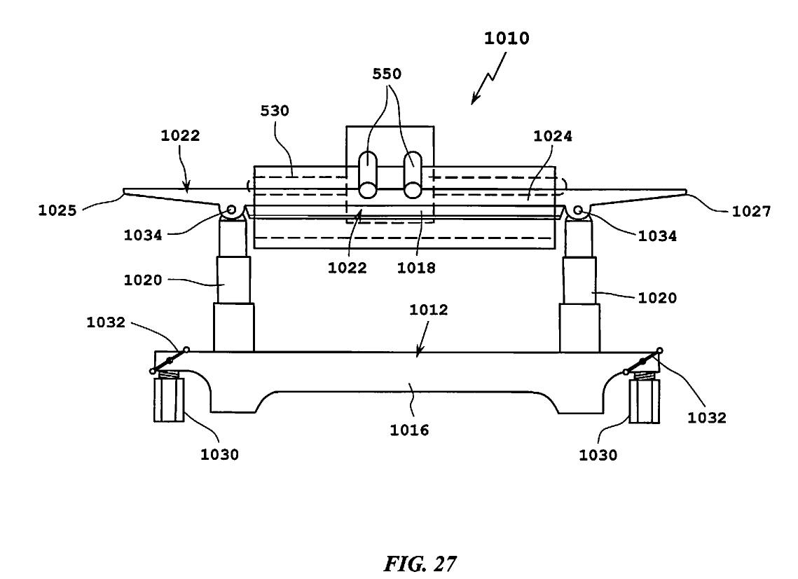

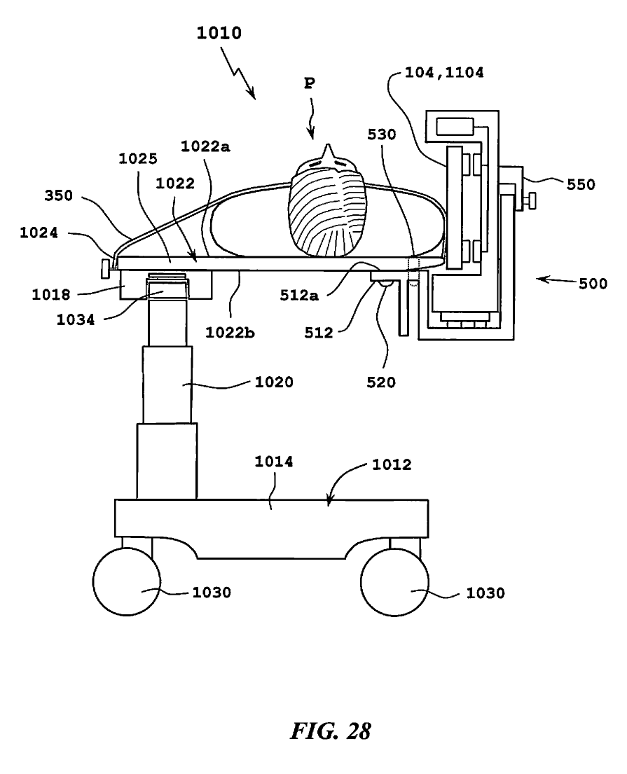

FIGS. 27-28 illustrate the patient table 1010 having the patient pallet 1022 with the patient P lying on the upper surface 1022a of the pallet 1022. In this exemplary embodiment, the mounting apparatus is only the support structure 500. The upper surface 512a of the projection 512 is now interfacing with the lower surface 1022b of the pallet 1022 and the support structure 500 is configured to substantially orthogonally position the platform 104 of the vibrational therapy assembly 100 or the upper plate 1104 of the vibrational therapy assembly 1100 with respect to the surface 1022a of the pallet 1022. The support structure 500 may be secured to the pallet 1022 via bolts 520 penetrating through an aperture in the first projection 512 through from the lower surface 512b through the upper surface 512a and at least partially into pallet 1022. Alternatively, or in addition thereto, the support structure 500 may be secured to the pallet 1022 via a band or strap 530 disposed in the channel 516 to support the lower surface 512b of the first projection 512, and extend around the upper surface 1022a of the patient pallet 1022.

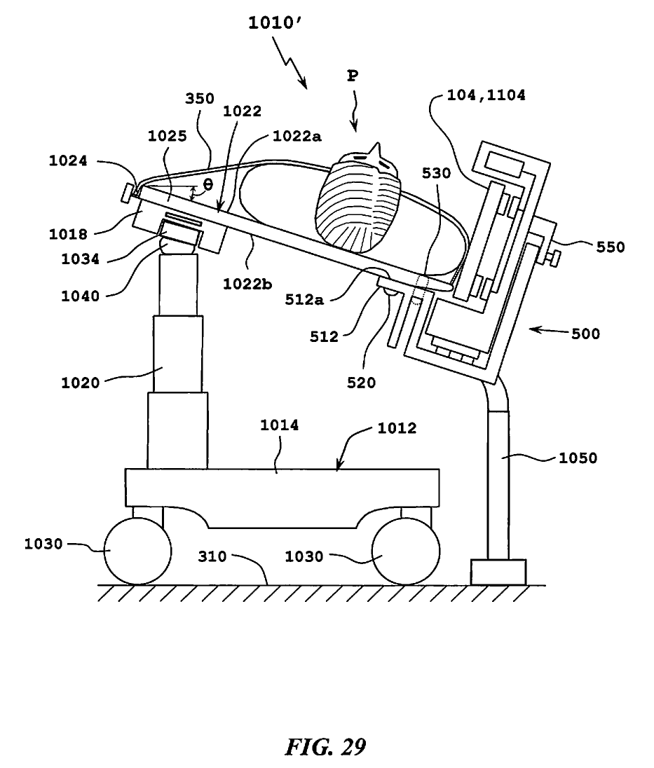

FIG. 29 is an end view of a patient table 1010′ having the patient pallet 1022 wherein the patient table 1010′ differs from patient table 1010 in that patient table 1010′ further includes a pivot mechanism 1040 disposed between front and rear lift arms or hydraulic cylinders 1020 and the hinges 1034 securing the upper base 1018. The pivot mechanism 1040 enables the pallet 1022 and the patient P to be rolled over to one side at a particular roll angle θ to interface with the vibrating plate assembly 100 or 1100 on the side of the patient pallet 1022. The pallet 1022 and/or the support structure 500, as shown, may be additionally supported via a support stanchion 1050 that may rest on the floor 310.

Referring to FIG. 26, those skilled in the art will recognize that, and understand how, the bed 300 may also be configured to roll over at a roll angle such as roll angle θ to interface with the vibrating plate assembly 100 or 1100 on the side 306 of the bed 300.

As can be appreciated from the foregoing description, the present disclosure relates to at least one apparatus capable of producing resonant vibrations, such as at least one vibrational therapy apparatus that includes at least one platform member having at least one vibrating plate assembly for providing vibrational energy. The platform member is configured for mounting to a patient support structure such as a bed or a surface of a pallet. The vibrational therapy apparatus includes a mounting apparatus configured to receive the at least one vibrating plate assembly for securely positioning and removably mounting the at least one platform member to the patient support structure, such as with respect to a surface of the bed or of the pallet.

While several embodiments of the disclosure have been shown in the drawings and/or discussed herein, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

What is claimed is:

1. A vibrational therapy apparatus comprising:
at least one platform member including at least one vibrating plate assembly for providing vibrational energy, the at least one platform member configured for mounting to a patient support structure; and
a mounting apparatus configured to and adapted to support said at least one vibrating plate assembly for mounting said at least one platform member to the patient support structure.

2. The vibrational therapy apparatus according to claim 1, wherein the mounting apparatus is configured to and adapted to support said at least one vibrating plate assembly for removably mounting said at least one platform member to a patient support structure.

3. The vibrational therapy apparatus according to claim 1, further comprising:
at least one positioner operatively associated with said at least one platform member for guiding patient tissue adjacent said at least one vibrating plate assembly.

4. The vibrational therapy apparatus according to claim 3, wherein said at least one vibrating plate assembly provides vibrational energy in at least two configurations of said at least one positioner.

5. The vibrational therapy apparatus according to claim 4, wherein, in one configuration of said at least two configurations, said at least one positioner is substantially perpendicular to said at least one platform member.

6. The vibrational therapy apparatus according to claim 4, wherein, in one configuration of said at least two configurations, said at least one positioner is in juxtaposed relation to said at least one platform member.

7. The vibrational therapy apparatus according to claim 3, wherein said at least one positioner is moveable between a first position and a second position.

8. The vibrational therapy apparatus according to claim 4, wherein, in a first configuration of said at least two configurations, said patient tissue contacts said at least one vibrating plate assembly, and, in a second configuration of said at least two configurations, said patient tissue does not contact said at least one vibrating plate assembly.

9. The vibrational therapy apparatus according to claim 3, further comprising at least one locating member operatively associated with one of said at least one platform member and said at least one positioner.

10. A mounting apparatus configured to support at least one apparatus capable of producing resonant vibrations, wherein the mounting apparatus is configured for and adapted for mounting the at least one apparatus capable of producing resonant vibrations to a patient support structure.

11. The mounting apparatus according to claim 10, wherein the mounting apparatus is configured for and adapted for removably mounting the at least one apparatus capable of producing resonant vibrations to a patient support structure.

12. The mounting apparatus according to claim 10, wherein the apparatus capable of producing resonant vibrations is a vibrational therapy apparatus comprising:
at least one platform member including at least one vibrating plate assembly for providing vibrational energy, the at least one platform member configured for mounting to the patient support structure; and
wherein the mounting apparatus is configured to and adapted to support said at least one vibrating plate assembly to mount said at least one platform member to the patient support structure.

13. The mounting apparatus according to claim 12, wherein the mounting apparatus mounts the at least one vibrating plate assembly substantially orthogonally with respect to the patient support structure.

14. The mounting apparatus according to claim 10, wherein the mounting apparatus comprises a support structure configured to and adapted to support the at least one apparatus capable of producing resonant vibrations to the patient support structure.

15. The mounting apparatus according to claim 10, wherein the at least one apparatus capable of producing resonant vibrations is at least one of (a) a vibrational therapy assembly; (b) a vibrational therapy apparatus; (c) a vibrating plate assembly; and (d) an oscillating platform apparatus.

16. A vibrational therapy assembly comprising:
a first vibrational therapy apparatus comprising:
a first platform member including at least one vibrating plate assembly for providing vibrational energy, the first platform member configured for and adapted for mounting to a patient support structure; and
a second vibrational therapy apparatus comprising:
a second platform member including at least one vibrating plate assembly for providing vibrational energy, the second platform member configured for and adapted for mounting to a patient support structure;
connecting means for removably connecting said first and second vibrational therapy apparatus; and
a mounting apparatus configured to and adapted to support said first vibrational therapy apparatus for mounting said first platform member to a patient support structure, said mounting apparatus further configured to and adapted to support said second vibrational therapy apparatus for mounting said second platform member to a patient support structure.

17. The vibrational therapy assembly according to claim 16, further comprising:
a first positioner operatively associated with said first platform member for guiding patient tissue adjacent said at least one vibrating plate assembly; and
a second positioner operatively associated with said second platform member for guiding patient tissue adjacent said at least one vibrating plate assembly.

18. The vibrational therapy assembly according to claim 17,
wherein said at least one vibrating plate assembly of said first positioner provides vibrational energy in at least two configurations of said first positioner, and
wherein said at least one vibrating plate assembly of said second positioner provides vibrational energy in at least two configurations of said second positioner.

19. The vibrational therapy assembly according to claim 16, wherein said means for removably connecting engages and disengages said first vibrational therapy apparatus from said second vibrational therapy apparatus.

20. The assembly according to claim 16, further comprising:
a first locating member operatively associated with said first vibrational therapy apparatus; and
a second locating member operatively associated with said second vibrational therapy apparatus.

21. The assembly according to claim 16, wherein said first and second positioners are in juxtaposed relation to said first and second platform members, and wherein said first vibrational therapy apparatus is in juxtaposed relation to said second vibrational therapy apparatus.

22. The assembly according to claim 21, wherein said first and second platform members define at least one handle.

23. A vibrational therapy system comprising:
a patient support structure;
a vibrational therapy apparatus comprising:
at least one platform member including at least one vibrating plate assembly for providing vibrational energy, the at least one platform member configured for mounting to the patient support structure; and
a mounting apparatus configured to and adapted to mount said at least one platform member to the patient support structure.

24. A vibrational therapy system according to claim 23,
wherein the patient support structure comprises a receptacle member, and
wherein the mounting apparatus mounts said at least one platform member to the patient support structure via a restraining member configured with at least one engagement member fixedly secured to the receptacle member.

25. A vibrational therapy system according to claim 24, wherein the restraining member is a belt and the at least one engagement member is a velcro pad at an end of the belt, and wherein the receptacle member is a velcro patch engaged by the pad.

26. A vibrational therapy system according to claim 23, wherein the mounting apparatus comprises at least a first pair of joining members configured for interfacing therebetween and a second pair of joining members at least one of the second pair being mounted to the patient support structure, the second pair of joining members configured for interfacing therebetween to mount said at least one platform member to the patient support structure.

27. A method for providing vibrational therapy, said method comprising:
providing at least one apparatus capable of producing resonant vibrations;
providing a patient support structure;
mounting the at least one apparatus capable of producing resonant vibrations to the patient support structure;
contacting patient tissue to the at least one apparatus capable of producing resonant vibrations; and
actuating the at least one apparatus capable of producing resonant vibrations to produce resonant vibrations.

28. The method according to claim 27, wherein the at least one apparatus capable of producing resonant vibrations is at least one vibrating plate assembly, and the method further comprises the steps of:
providing a platform member having the at least one vibrating plate assembly;
providing a patient support structure;
mounting the platform member to the patient support structure;
guiding patient tissue over said at least one vibrating plate assembly using a positioner operatively associated with said platform member; and
actuating said at least one vibrating plate assembly.

29. The method according to claim 28, further comprising the step of adjusting said positioner relative to said platform member.

30. The method according to claim 28, wherein the step of guiding patient tissue includes the step of having the patient stand on said positioner.

31. The method according to claim 28, wherein the step of guiding patient tissue includes the step of placing at least a portion of a patient's leg onto said platform member.
